(19) United States
(12) Patent Application Publication
(10) Pub. No.: US 2004/0188547 A1
(43) Pub. Date: Sep. 30, 2004

(54) Developer dispensing nozzle with movable shutter plates

(75) Inventors: Yao-Hwan Kao, Hsinchu (TW); Ming-Yeon Hung, Hsin-Chu (TW); Der-Fang Huang, Hsinchu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/400,759

(22) Filed: Mar. 26, 2003

(51) Int. Cl. B05B 9/00

(52) U.S. Cl. 239/455; 239/124

(57) ABSTRACT

A liquid dispensing nozzle beneficial in varying or controlling the quantity of a developing liquid dispensed onto various regions of a semiconductor wafer substrate during the photolithography step of semiconductor fabrication is disclosed. The liquid dispensing nozzle includes a nozzle housing which includes a bottom dispensing opening. A shutter plate in the nozzle housing is engaged by a shutter motor which displaces the shutter plate in the nozzle head and varies the position of the shutter plate with respect to the dispensing opening. The shutter plate opening narrows as the developing liquid is dispensed onto the edge of the substrate to prevent excessive application of the liquid onto those regions. The shutter plate widens the opening as the developing liquid is dispensed onto the central region of the substrate.

### FIELD OF THE INVENTION

The present invention relates to photolithography processes used in the formation of integrated circuit (IC) patterns on photoresist in the fabrication of semiconductor integrated circuits. More particularly, the present invention relates to a liquid developer dispensing nozzle having a movable shutter plate for controlling the quantity of liquid developer dispensed onto the edge and central regions of a wafer in order to prevent dispensing of excessive quantities of the developer onto the edge regions of the wafer.

### BACKGROUND OF THE INVENTION

The fabrication of various solid state devices requires the use of planar substrates, or semiconductor wafers, on which integrated circuits are fabricated. The final number, or yield, of functional integrated circuits on a wafer at the end of the IC fabrication process is of utmost importance to semiconductor manufacturers, and increasing the yield of circuits on the wafer is the main goal of semiconductor fabrication. After packaging, the circuits on the wafers are tested, wherein non-functional dies are marked using an inking process and the functional dies on the wafer are separated and sold. IC fabricators increase the yield of dies on a wafer by exploiting economies of scale. Over 1000 dies may be formed on a single wafer which measures from six to twelve inches in diameter.

Various processing steps are used to fabricate integrated circuits on a semiconductor wafer. These steps include deposition of a conducting layer on the silicon wafer substrate; formation of a photoresist or other mask such as titanium oxide or silicon oxide, in the form of the desired metal interconnection pattern, using standard lithographic or photolithographic techniques; subjecting the wafer substrate to a dry etching process to remove the conducting layer from the areas not covered by the mask, thereby etching the conducting layer in the form of the masked pattern on the substrate; removing or stripping the mask layer from the substrate typically using reactive plasma and chlorine gas, thereby exposing the top surface of the conductive interconnect layer; and cooling and drying the wafer substrate by applying water and nitrogen gas to the wafer substrate.

Photoresist materials are coated onto the surface of a wafer by dispensing a photoresist fluid typically on the center of the wafer as the wafer rotates at high speeds within a stationary bowl or coater cup. The coater cup catches excess fluids and particles ejected from the rotating wafer during application of the photoresist. The photoresist fluid dispensed onto the center of the wafer is spread outwardly toward the edges of the wafer by surface tension generated by the centrifugal force of the rotating wafer. This facilitates uniform application of the liquid photoresist on the entire surface of the wafer.

During the photolithography step of semiconductor production, light energy is applied through a reticle mask onto the photoresist material previously deposited on the wafer to define circuit patterns which will be etched in a subsequent processing step to define the circuits on the wafer. A reticle is a transparent plate patterned with a circuit image to be formed in the photoresist coating on the wafer. A reticle contains the circuit pattern image for only a few of the die on a wafer, such as four die, for example, and thus, must be stepped and repeated across the entire surface of the wafer. In contrast, a photomask, or mask, includes the circuit pattern image for all of the die on a wafer and requires only one exposure to transfer the circuit pattern image for all of the dies to the wafer.

The numerous processing steps outlined above are used to cumulatively apply multiple electrically conductive and insulative layers on the wafer and pattern the layers to form the circuits. The final yield of functional circuits on the wafer depends on proper application of each layer during the process steps. Proper application of those layers depends, in turn, on coating the material in a uniform spread over the surface of the wafer in an economical and efficient manner.

Spin coating of photoresist on wafers, as well as the other steps in the photolithography process, is carried out in an automated coater/developer track system using wafer handling equipment which transport the wafers between the various photolithography operation stations, such as vapor prime resist spin coat, develop, baking and chilling stations. Robotic handling of the wafers minimizes particle generation and wafer damage. Automated wafer tracks enable various processing operations to be carried out simultaneously. Two types of automated track systems widely used in the industry are the TEL (Tokyo Electron Limited) track and the SVG (Silicon Valley Group) track.

A typical method of forming a circuit pattern on a wafer includes introducing the wafer into the automated track system and then spin-coating a photoresist layer onto the wafer. The photoresist is next cured by conducting a soft bake process. After it is cooled, the wafer is placed in an alignment and exposure apparatus, such as a stepper, which aligns the wafer with an array of die patterns etched on the typically chrome-coated quartz reticle. When properly aligned and focused, the stepper exposes a small area of the wafer, then shifts or “steps” to the next field and repeats the process until the entire wafer surface has been exposed to the die patterns on the reticle. The photoresist, which may be either positive or negative, is exposed to light through the reticle in the circuit image pattern. Negative photoresist is cross-linked, or hardened, by exposure to UV light in the image of the circuit pattern, and therefore the exposed regions are rendered insoluble and the unexposed regions are rendered soluble to developer solution. The light-exposed regions of positive photoresist, on the other hand, are rendered soluble to developer solution after exposure to the UV light, whereas the unexposed regions remain insoluble to the developer solution. After the aligning and exposing step, the wafer is exposed to post-exposure baking and then is developed and hard-baked, and finally, inspected.

During the photoresist development step, a liquid chemical developer is applied to the wafer to dissolve the soluble regions of the resist that were formed during mask or reticle exposure. Accordingly, in the case of negative photoresist, the soluble, unexposed regions of the photoresist are dissolved and the insoluble, cross-linked exposed regions remain in the form of the circuit pattern. In the case of positive photoresist, the soluble, exposed regions of the photoresist are dissolved and the insoluble, unexposed regions remain in the form of the circuit pattern.

The circuit pattern defined by the developed and hardened photoresist is next transferred to the underlying metal conductive layer using a metal etching process, in which metal over the entire surface of the wafer and not covered by the photoresist is etched away from the wafer with the metal under the photoresist that defines the circuit pattern protected from the etchant. As a result, a well-defined pattern of metallic microelectronic circuits which closely approximates the photoresist circuit pattern remains in the metal layer.

A top schematic view of a typical conventional developer dispensing apparatus 10 for dispensing a developing liquid 16 onto a semiconductor wafer 18 is shown in FIG. 1. The apparatus 10 includes an elongated dispensing head 12 having multiple dispensing nozzles 14 through which the developing liquid 16 is dispensed onto the surface of the wafer 18. Throughout the developing liquid dispensing process, the dispensing head 12 migrates horizontally over the wafer 18 in the direction indicated by the arrow 20 to coat the wafer 18 with the developing liquid 16.

One of the drawbacks associated with the conventional apparatus 10 is that equal quantities of the developing liquid 16 are dispensed among all regions on the surface of the wafer 18. Consequently, excessive quantities of the developing liquid 16 are dispensed on the edge regions of the wafer 18 when the dispensing head 12 is positioned over the edge regions of the wafer 18. Accordingly, an apparatus having a new and improved developer dispensing nozzle is needed for reducing the quantity of developing liquid dispensed onto the edge regions of a wafer while dispensing sufficient quantities of the developing liquid onto the central regions of the wafer.

An object of the present invention is to provide a liquid dispensing nozzle which facilitates substantially uniform dispensing of a liquid on a substrate.

Another object of the present invention is to provide a new and improved liquid dispensing nozzle which facilitates the efficient use of a developing liquid while dispensing the liquid onto a semiconductor wafer substrate.

Still another object of the present invention is to provide a new and improved liquid dispensing nozzle which prevents or reduces wasting of a liquid as the liquid is dispensed onto a substrate.

Yet another object of the present invention is to provide a new and improved liquid dispensing nozzle which dispenses smaller quantities of a liquid onto the edge regions of a substrate relative to the central region of the substrate to prevent wasting of the liquid.

A still further object of the present invention is to provide a new and improved liquid dispensing nozzle which includes a shutter for varying the size of a liquid dispensing opening in the nozzle in order to vary the quantity of liquid dispensed onto the substrate through the opening

Yet another object of the present invention is to provide a liquid dispensing nozzle which may be used for dispensing a liquid onto a substrate in a variety of applications.

### SUMMARY OF THE INVENTION

In accordance with these and other objects and advantages, the present invention is generally directed to a new and improved liquid dispensing nozzle which is particularly beneficial in varying or controlling the quantity of a developing liquid dispensed onto various regions of a semiconductor wafer substrate during the photolithography step of semiconductor fabrication. The liquid dispensing nozzle includes a nozzle housing which includes a bottom dispensing opening. At least one shutter plate in the nozzle housing is engaged by a shutter motor which displaces the shutter plate in the nozzle head and varies the position of the shutter plate with respect to the dispensing opening. Accordingly, the shutter plate narrows the shutter opening as the developing liquid is dispensed onto the edge or peripheral regions of the substrate, to prevent excessive application of the liquid onto those regions and those regions of the dispensing tool adjacent to the substrate. Conversely, the shutter plate widens or dilates the opening as the developing liquid is dispensed onto the central region of the substrate.

### BRIEF DESCRIPTION OF THE DRAWINGS

The invention will now be described, by way of example, with reference to the accompanying drawings, in which:

FIG. 1 is a top schematic view of a typical conventional developer dispensing apparatus, dispensing a liquid developer onto a semiconductor wafer substrate;

FIG. 2 is a top schematic view, partially in section, of a developer dispensing apparatus incorporating the liquid dispensing nozzle of the present invention;

FIG. 3 is a cross-sectional view of the liquid dispensing nozzle of the present invention, taken along section lines 3-3 in FIG. 2;

FIG. 4A is a bottom schematic view of the liquid dispensing nozzle of the present invention, illustrating partial narrowing of the dispensing opening by operation of the shutter plates as a liquid is dispensed onto a first edge region of a substrate;

FIG. 4B is a bottom schematic view of the liquid dispensing nozzle of the present invention, illustrating partial widening of the dispensing opening by operation of the shutter plates as the dispensing head migrates toward the center of the substrate;

FIG. 4C is a bottom schematic view of the liquid dispensing nozzle of the present invention, illustrating complete widening of the dispensing opening by operation of the shutter plates as the dispensing head is positioned over the center of the substrate;

FIG. 4D is a bottom schematic view of the liquid dispensing nozzle, illustrating partial narrowing of the dispensing opening as the dispensing head migrates from the center region toward the opposite or second edge region of the substrate; and

FIG. 4E is a bottom schematic view of the liquid dispensing nozzle, illustrating narrowing of the dispensing opening by operation of the shutter plates as the dispensing head reaches the second edge region of the substrate.

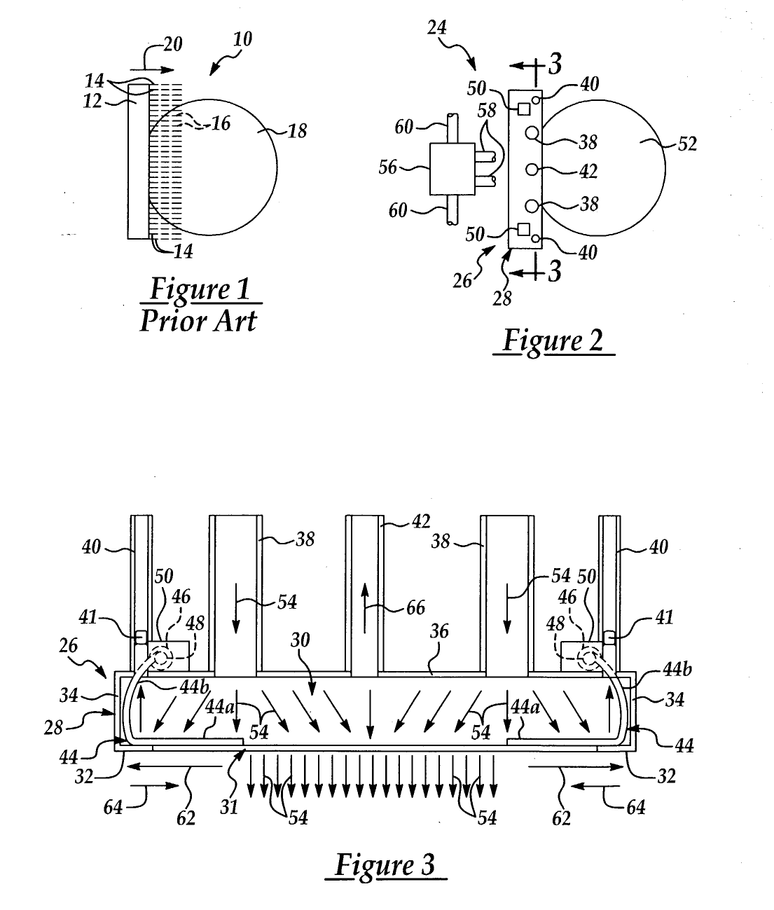

### DESCRIPTION OF THE PREFERRED EMBODIMENTS

The present invention has particularly beneficial utility in controlling the quantity or volume of a developing liquid dispensed onto various regions of a semiconductor wafer substrate in order to prevent wasting of the developing liquid, particularly at the edge regions of the substrate. However, the invention is not so limited in application, and while references may be made to such developing liquid and semiconductor wafer substrate, the present invention is more generally applicable to controlling the quantity of a liquid dispensed onto various regions of a substrate in a variety of mechanical and industrial applications.

Referring to FIGS. 2 and 3, an illustrative embodiment of a developer dispensing apparatus 24 includes a dispensing nozzle 26 of the present invention. The dispensing nozzle 26 includes a typically elongated housing 28. As shown in FIG. 3, the housing 28 typically includes a top panel 36, side walls 34 extending downwardly from the top panel 36, and a pair of bottom flanges 32 extending horizontally from the side walls 34. A dispensing opening 31 defined between the bottom flanges 32 communicates with a housing interior 30 inside the housing 28. In operation of the dispensing nozzle 26 as hereinafter described, the dispensing opening 31 is selectively constricted or dilated by typically concerted operation of a pair of shutter plates 44.

As shown in FIG. 2, a pair of outlet conduits 58 extends from a supply tank 56 which contains a supply of developing liquid 54 (FIG. 3). Each of a pair of developer supply conduits 38, provided in fluid communication with the housing interior 30 as shown in FIG. 3, is provided in fluid communication with the corresponding outlet conduit 58. A pair of developer return conduits 40, each of which may be fitted with an electronic needle valve 41, extends from the housing 28, in fluid communication with the housing interior 30, and each is provided in fluid communication with a corresponding inlet conduit 60 that communicates with the supply tank 56. An air vent conduit 42 typically extends from the housing 28, in fluid communication with the housing interior 30, for venting air pressure in the housing interior 30. Accordingly, in operation of the dispensing nozzle 26 as hereinafter described, developing liquid 54 is pumped from the supply tank 56, through the outlet conduits 58 and developer supply conduits 38, respectively, 15 and into the housing interior 30. Depending on the size of the dispensing opening 31 as determined by the positions of the shutter plates 44, a selected quantity or volume of the developing liquid 54 is dispensed through the dispensing opening 31. Excess developing liquid 54 is recycled back to the supply tank 56 through the developer return conduits 40 and the respective inlet conduits 60.

Each of a pair of motor housings 50 is provided on the top panel 36 of the housing 28 and contains a drive motor 46 that engages a drive shaft 48. A pair of shutter plates 44, each of which is constructed of a suitable flexible material, is provided in the housing interior 30. Each shutter plate 44 includes a horizontal flat segment 44a, which may be supported by the corresponding bottom flange 32 of the housing 28 and is slidably secured in position inside the housing interior 30, according to the knowledge of those skilled in the art. A coiled segment 44b which extends from the flat segment 44a extends through an opening (not shown) in the top panel 36 into the housing 50, where the coiled segment 44b is coiled around the corresponding shaft 48 in the motor housing 50. Accordingly, by rotation of each shaft 48 by operation of the corresponding drive motor 46, the coiled segment 44b is wound on the shaft 48. Consequently, the flat segment 44a slides in the direction indicated by the arrow 62, such that the shutter plates 44 widen or dilate the dispensing opening 31 at the respective ends thereof. Conversely, by opposite rotation of each shaft 48 by operation of the drive motor 46, the coiled segment 44b is unwound from the corresponding shaft 48 and the flat segment 44a slides in the direction indicated by the arrow 64, such that the shutter plates 44 narrow or constrict the dispensing opening 31 at the respective ends thereof.

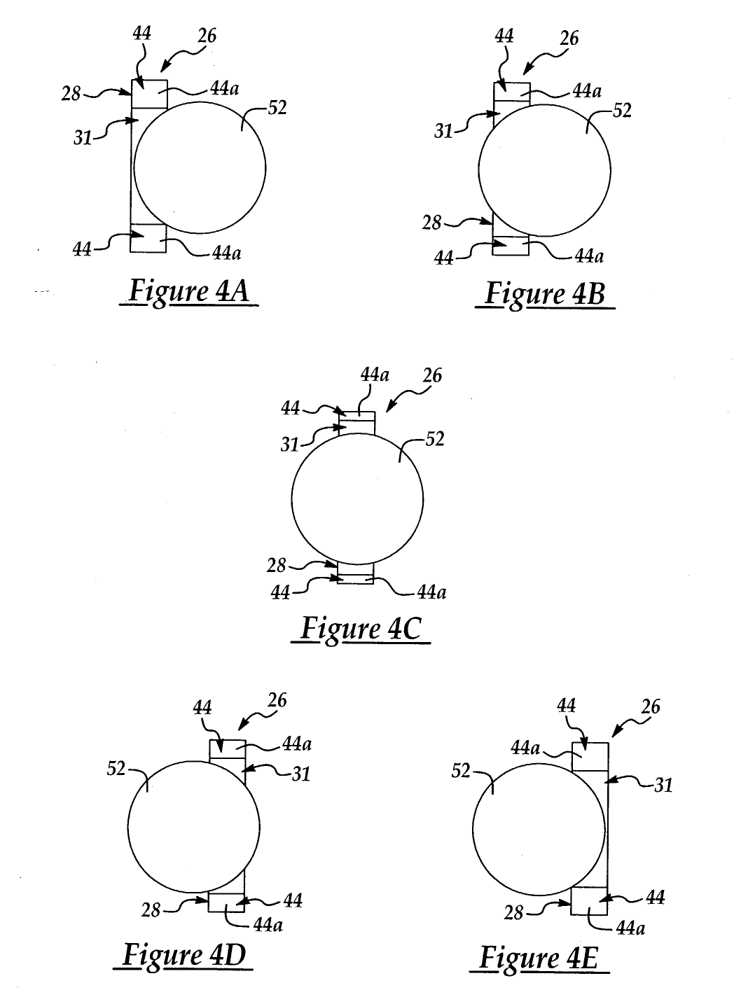

In operation of the dispensing nozzle 26, the housing 28 is initially positioned over an edge portion of a substrate 52 preparatory to dispensing developing liquid 54 onto the surface of the substrate 52, as shown in FIG. 4A. At that position of the housing 28, the shutter plates 44 are positioned in such a manner that the dispensing opening 31 covers the entire edge region of the substrate 52, while the shutter plates 44 cover the portions of the dispensing opening 31 that are not positioned directly over the substrate 52. Accordingly, as developing liquid 54 is pumped from the supply tank 56, through the outlet conduits 58 and respective developer supply conduits 38, and into the housing interior 30, most or all of the developing liquid 54 is dispensed onto the edge region of the substrate 52. It will be appreciated by those skilled in the art that the flat segment 44a of each shutter plate 44 prevents excess developing liquid 54 from being dispensed through the dispensing opening 31 and falling onto the portions of the apparatus 24 adjacent to the substrate 52, since those portions of the dispensing opening 31 are substantially covered or blocked by the shutter plates 44. Accordingly, the excess developing liquid 54, blocked by the shutter plates 44, is pumped from the housing interior 30 and back to the supply tank 56 through the developer return conduits 40 and the respective inlet conduits 60. Flow of the developing liquid 54 through the developer return conduits 40 is controlled by actuation of the needle valves 41. Air pressure 66 is vented from the housing interior 30 through the air vent conduit 42.

As shown in FIGS. 4B-4E, the housing 28 of the dispensing nozzle 26 gradually migrates over the upper surface of the substrate 52 as the developing liquid 54 is dispensed onto the substrate 52 through the dispensing opening 31. As the housing 28 approaches the diameter of the substrate 52, as shown in FIG. 4B, the shutter plates 44 widen or dilate the dispensing opening 31 in order to facilitate dispensing of developing liquid 54 onto the entire surface of the substrate 52 spanned by the dispensing opening 31 while preventing dispensing of excess developing liquid 54 onto the areas of the apparatus 24 adjacent to the substrate 52. Accordingly, dilation of the dispensing opening 31 is facilitated by operation of the respective drive motors 46, wherein the drive shafts 48 are rotated to wind the coiled segments 44b of the shutter plates 44 on the respective drive shafts 48. This action slides the flat segments 44a of the respective shutter plates 44 in the housing interior 30 in the direction indicated by the arrows 62 in FIG. 3. When the migrating housing 28 reaches the center of the substrate 52, as shown in FIG. 4C, the shutter plates 44 are positioned in such a manner as to provide maximal dilation of the dispensing opening 31 in order to facilitate dispensing of developing liquid 54 onto the entire width of the substrate 52 spanned by the dispensing opening 31. The respective shutter plates 44 prevent excessive dispensing of the developing liquid 54 onto the edge regions of the substrate 52, as well as onto the areas of the apparatus 24 on the respective sides of the substrate 52, to prevent or minimize wasting of the developing liquid 54.

As the housing 28 continues to migrate over the surface of the substrate 52, as shown in FIGS. 4D and 4E, the dispensing opening 31 begins to narrow or constrict by reverse operation of the respective drive motors 46. Accordingly, as shown in FIG. 3, the drive shafts 48 are rotated to unwind the coiled segments 44b of the respective shutter plates 44 and extend the flat segment 44a of each shutter plate 44 in the direction indicated by the arrows 64. This prevents excessive developing liquid 54 from being dispensed onto the edge regions of the substrate 52, as well as onto the areas of the developer dispensing apparatus 24 adjacent to the substrate 52. Finally, the shutter plates 44 constrict the width of the dispensing opening 31 still further as the housing 28 is positioned over the far edge portion of the substrate 52 and the developing liquid 54 is dispensed onto that portion of the substrate 52.

While the preferred embodiments of the invention have been described above, it will be recognized and understood that various modifications can be made in the invention and the appended claims are intended to cover all such modifications which may fall within the spirit and scope of the invention.

What is claimed is:

1. A dispensing nozzle for dispensing a liquid onto a substrate, comprising:
a housing for receiving the liquid;
a dispensing opening provided in said housing for dispensing the liquid from said housing; and
at least one shutter plate provided in said housing for selectively dilating and constricting said dispensing opening.

2. The dispensing nozzle of claim 1 wherein said at least one shutter plate comprises a pair of shutter plates.

3. The dispensing nozzle of claim 1 further comprising an air vent conduit provided in communication with said housing for venting air from said housing.

4. The dispensing nozzle of claim 3 wherein said at least one shutter plate comprises a pair of shutter plates.

5. The dispensing nozzle of claim 1 further comprising a drive motor operably engaging said at least one shutter plate for displacing said at least one shutter plate in said housing and selectively dilating and constricting said dispensing opening.

6. The dispensing nozzle of claim 5 wherein said at least one shutter plate comprises a pair of shutter plates.

7. The dispensing nozzle of claim 5 further comprising an air vent conduit provided in communication with said housing for venting air from said housing.

8. The dispensing nozzle of claim 7 wherein said at least one shutter plate comprises a pair of shutter plates.

9. A dispensing nozzle for dispensing a liquid onto a substrate, comprising:
a housing;
at least one supply conduit provided in fluid communication with said housing for dispensing the liquid into said housing;
a dispensing opening provided in said housing for dispensing the liquid from said housing; and
at least one shutter plate provided in said housing for selectively dilating and constricting said dispensing opening.

10. The dispensing nozzle of claim 9 wherein said at least one shutter plate comprises a pair of shutter plates.

11. The dispensing nozzle of claim 9 further comprising an air vent conduit provided in communication with said housing for venting air from said housing.

12. The dispensing nozzle of claim 9 further comprising a drive motor operably engaging said at least one shutter plate for displacing said at least one shutter plate in said housing and selectively dilating and constricting said dispensing opening.

13. The dispensing nozzle of claim 9 wherein said at least one supply conduit comprises a pair of supply conduits.

14. The dispensing nozzle of claim 13 wherein said at least one shutter plate comprises a pair of shutter plates.

15. The dispensing nozzle of claim 13 further comprising an air vent conduit provided in communication with said housing for venting air from said housing.

16. The dispensing nozzle of claim 13 further comprising a drive motor operably engaging said at least one shutter plate for displacing said at least one shutter plate in said housing and selectively dilating and constricting said dispensing opening.

17. A dispensing nozzle for dispensing a liquid onto a substrate, comprising:
a supply tank for containing the liquid;
a housing for receiving the liquid from said supply tank;
a dispensing opening provided in said housing for dispensing a first portion of the liquid from said housing;
at least one shutter plate provided in said housing for selectively dilating and constricting said dispensing opening; and
at least one return conduit provided in fluid communication with said housing and said supply tank for distributing a second portion of the liquid from said housing to said supply tank.

18. The dispensing nozzle of claim 17 wherein said at least one shutter plate comprises a pair of shutter plates.

19. The dispensing nozzle of claim 17 further comprising an air vent conduit provided in communication with said housing for venting air from said housing.

20. The dispensing nozzle of claim 17 further comprising a drive motor operably engaging said at least one shutter plate for displacing said at least one shutter plate in said housing and selectively dilating and constricting said dispensing opening.
